(19) United States
(12) Patent Application Publication
(10) Pub. No.: US 2021/0063530 A1
(43) Pub. Date: Mar. 4, 2021

(54) RADIO WAVE TRANSMISSIVE COVER

(71) Applicant: TOYODA GOSEI CO., LTD., Kiyosu-shi (JP)

(72) Inventors: Shinichi DOKE, Kiyosu-shi (JP); Eiji KOJIMA, Kiyosu-shi (JP)

(21) Appl. No.: 17/003,221

(22) Filed: Aug. 26, 2020

(30) Foreign Application Priority Data
Sep. 2, 2019 (JP) 2019-159340

(51) Int. Cl. G01S 7/03

(52) U.S. Cl. CPC G01S 7/032; G01S 13/931

(57) ABSTRACT

A radio wave transmissive cover includes a conductive thin film. The conductive thin film includes unit thin film sections each including a hole region, a conduction region, and a patch region. Expressions 1 to 3 hold among a radius r of the patch region, a minimum dimension c of the conduction region, a width w of the hole region, a frequency frmin, frequencies f1, f2, and an index value Q.

$$\begin{matrix}frmin = - 91 r - 7.2 c + 11.8 w + 113.5 & ( Expression 1 ) \\ Q = \frac{Kr}{\vert f 1 - f 2 \vert} & ( Expression 2 ) \\ Q = 79 r - 2.4 c + 23 w - 38.6 & ( Expression 3 )\end{matrix}$$

The radius r, the minimum dimension c, and the width w are determined based on Expressions 1 to 3 such that the frequency frmin is in a range from 70 GHz to 80 GHz and that the index value Q is in a range from −15 to −5.

### BACKGROUND

### 1. Field

The present disclosure relates to a radio wave transmissive cover that is configured to be arranged in a path of radio waves of a radio wave radar device.

### 2. Description of Related Art

In a vehicle equipped with a radio wave radar device such as a millimeter wave radar device, the radio wave radar device transmits radio waves, such as millimeter waves, to the outside of the vehicle. The radio waves that hit, and are reflected by, an object outside the vehicle, such as a leading vehicle or a pedestrian, are received by the radio wave radar device. The transmitted and received radio waves allow for recognition of the object, and detection of the distance and relative velocity between the vehicle and the object.

In the above-described vehicle, a radio wave transmissive cover is arranged in front of the radar device in the transmission direction of radio waves. The radio wave transmissive cover decorates the vehicle and has transmissiveness for radio waves that are transmitted and received by the radio wave radar device.

Typically, the above-described radio wave radar device is configured to temporarily stop detection when snow accumulates on the radio wave transmissive cover. However, due to widespread use of radio wave radar devices, it is desired that detection be capable of being performed during snowfall.

Accordingly, radio wave transmissive covers equipped with a snow melting function have been developed. According to an example, a radio wave transmissive cover includes a thin and extended conductor. When ice and snow accumulate on the radio wave transmissive cover, the conductor is energized to generate heat, melting the ice and snow. Such melting of ice and snow limits reduction in the detection performance of the radio wave radar device caused by radio wave attenuation due to accumulation of ice and snow.

In a radio wave transmissive cover equipped with a snow melting function as described above, the conductor may block radio waves. Thus, the conductor in the radio wave transmissive cover of the above-described example is arranged to extend in a reciprocating manner. Sections of the conductor that are parallel with each other are arranged at a predetermined distance in between, so that radio waves can pass through the gap between the parallel sections. However, it is not clear as to how much influence the conductor exerts on the radio wave transmissivity of the radio wave transmissive cover. The radio wave transmissivity required for a radio wave transmissive cover thus may not be achieved.

### SUMMARY

Accordingly, exemplary embodiments provide a radio wave transmissive cover that ensures radio wave transmissivity while having a snow melting function.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a radio wave transmissive cover used for a radio wave radar device configured to transmit and receive radio waves is provided. The radio wave transmissive cover includes a base made of a plastic and a conductive thin film. The base is configured to be arranged in a path of the radio waves and having transmissiveness for the radio waves. The conductive thin film is configured to be arranged in the path and generate heat when energized. The conductive thin film includes square unit thin film sections that are arranged regularly. Each unit thin film section includes a hole region including an annular hole, a conduction region located on an outer side of the hole region, and a patch region that is surrounded by the hole region and insulated. Expressions 1 to 3 hold among a radius r of the patch region, a minimum dimension c of the conduction region in a radial direction of the hole region, a width w of the hole region, a frequency frmin at which a reflectivity Kr of the radio waves is minimized, frequencies f1, f2 of edges of a band including the frequency frmin, and an index value Q related to the reflectivity Kr and a frequency band.

$$\begin{matrix}frmin = - 91 r - 7.2 c + 11.8 w + 113.5 & ( Expression 1 ) \\ Q = \frac{Kr}{\vert f 1 - f 2 \vert} & ( Expression 2 ) \\ Q = 79 r - 2.4 c + 23 w - 38.6 & ( Expression 3 )\end{matrix}$$

The radius r, the minimum dimension c, and the width w are determined based on Expressions 1 to 3 such that the frequency frmin is in a range from 70 GHz to 80 GHz and that the index value Q is in a range from −15 to −5.

Other features and aspects will be apparent from the following detailed description, the drawings, and the claims.

### BRIEF DESCRIPTION OF THE DRAWINGS

FIG. 1 is a partial vertical cross-sectional view showing a cross-sectional structure of a radio wave transmissive cover according to a first embodiment, together with a radio wave radar device.

FIG. 2 is a partial front view of a conductive thin film according to the first embodiment.

FIG. 3 is a partial front view illustrating the relationship among dimensions of sections of a unit thin film section of FIG. 2.

FIG. 4 is a diagram showing the relationship between frequencies of radio waves and reflectivity.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

A radio wave transmissive cover 12 according to a first embodiment will now be described with reference to the drawings.

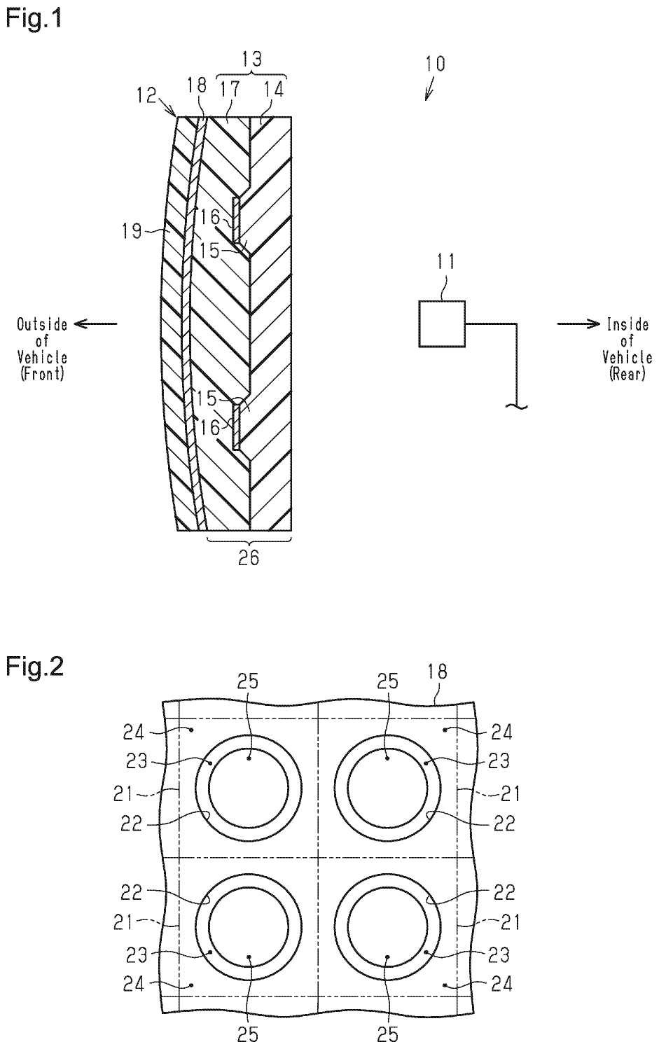

As shown in FIG. 1, a vehicle 10 is equipped with a radio wave radar device 11 such as a millimeter wave radar device. The radio wave radar device 11 is configured to transmit radio waves such as millimeter waves to the outside of the vehicle 10 (toward the left as viewed in FIG. 1) and receive the radio waves, which have hit, and been reflected by, an object outside the vehicle 10. The radio wave radar device 11 is also configured to detect the outside object through such transmission and reception of the radio waves. The in-vehicle radio wave radar device 11 transmits and receives millimeter-wave-type radio waves. Specifically, the radio wave radar device 11 transmits the radio waves while changing the radio waves within a frequency band that has a median of 76.5 GHz and a bandwidth of 1 GHz. The bandwidth is thus from 76 GHz to 77 GHz. The wavelength of radio waves having a frequency of 76.5 GHz is approximately 3.92 mm.

The radio wave transmissive cover 12 is located in front of the radio wave radar device 11 in the transmission direction of radio waves. The radio wave transmissive cover 12 is arranged in a path of radio waves transmitted and received by the radio wave radar device 11 and is attached to the vehicle 10.

The framework of the radio wave transmissive cover 12 includes a base 13 made of a dielectric substance. A rear section of the base 13 in the transmission direction includes a rear base 14. A front section of the base 13 in the transmission direction includes a front base 17. The rear base 14 is made of acrylonitrile-styrene-acrylate copolymer (ASA) plastic. The rear base 14 has protrusions 15 on a front surface in the transmission direction. Design layers 16 are provided on front end faces of the protrusions 15 in the transmission direction. The design layers 16 are made of metal films and have metallic luster. If a metal film were provided over the entire surface in a continuous manner, radio waves would be blocked or significantly attenuated. The metal films are thus provided by subjecting sections to sputtering or vapor-deposition with a metal material such as indium (In), such that the metal films have island-like structures. The island-like structure refers to a structure in which no single film covering the entire surface is provided, and a great number of slightly separated or partly contacting island-like metal films are laid over the surface. Due to this structure, the metal films have a discontinuous structure and thus have a high electrical resistance and a radio wave transmissivity. The design layers 16 decorate the protrusions 15.

The front base 17 is made of a transparent polycarbonate plastic. The front base 17 covers the protrusions 15 and other structures of the rear base 14 from the front in the transmission direction.

A conductive thin film 18 is stacked on the front surface of the base 13 in the transmission direction. When energized, the conductive thin film 18 generates heat and functions as a heater. In the first embodiment, the conductive thin film 18 is transparent and made of a conductive film such as a silver (Ag) film. The conductive thin film 18 is covered with a protective layer 19, which is made of a transparent plastic such as a polycarbonate plastic.

The conductive thin film 18 will now be described.

FIG. 2 shows a section of the conductive thin film 18 as viewed from the front in the transmission direction. In addition to the function as a heater, the conductive thin film 18 has a function similar to a bandpass filter. That is, the conductive thin film 18 allows for passage of radio waves in a specific frequency band and restricts passage of radio waves in other frequency bands. The conductive thin film 18 of the first embodiment is configured such that the frequency band of the radio waves transmitted and received by the radio wave radar device 11, for example, a frequency band from 76 GHz to 77 GHz is a pass band.

The conductive thin film 18 includes square unit thin film sections 21. The unit thin film sections 21 are regularly arranged to form a column in the vertical direction (up-down direction in FIG. 2) and a row in a lateral direction (left-right direction in FIG. 2). The individual unit thin film sections 21 are not physically separated from each other, but continuous with each other.

Each unit thin film section 21 includes a hole region 23, a conduction region 24, and a circular patch region 25. The hole region 23 includes an annular hole 22. The conduction region 24 is a section on the outer side of the hole region 23 and generates heat when energized. The patch region 25 is surrounded by the hole region 23 to be insulated, so that no current flows through the patch region 25. The hole region 23 is formed, for example, by removing a section of the conductive thin film 18 by irradiating the section with a laser beam or melting (etching) a section of the conductive thin film 18.

The hole regions 23 in adjacent two of the unit thin film sections 21 are separated from each other by a predetermined distance. The distance is preferably set to a value that does not cause grating lobes.

The size of the patch region 25 is determined such that, when radio waves transmitted from the radio wave radar device 11 reach the patch region 25, the patch region 25 outputs radio waves having a wavelength equivalent to that of the radio waves transmitted from the radio wave radar device 11. Specifically, the perimeter of the hole region 23 is determined to be equivalent to the wavelength of the radio waves transmitted from the radio wave radar device 11 (in this case, approximately 3.92 mm). The distance between the hole regions 23 or the distance between the patch regions 25 is determined such that the conductive thin film 18 has the required heat generating performance, in other words, a heat generating performance capable of melting ice and snow accumulated on the radio wave transmissive cover 12.

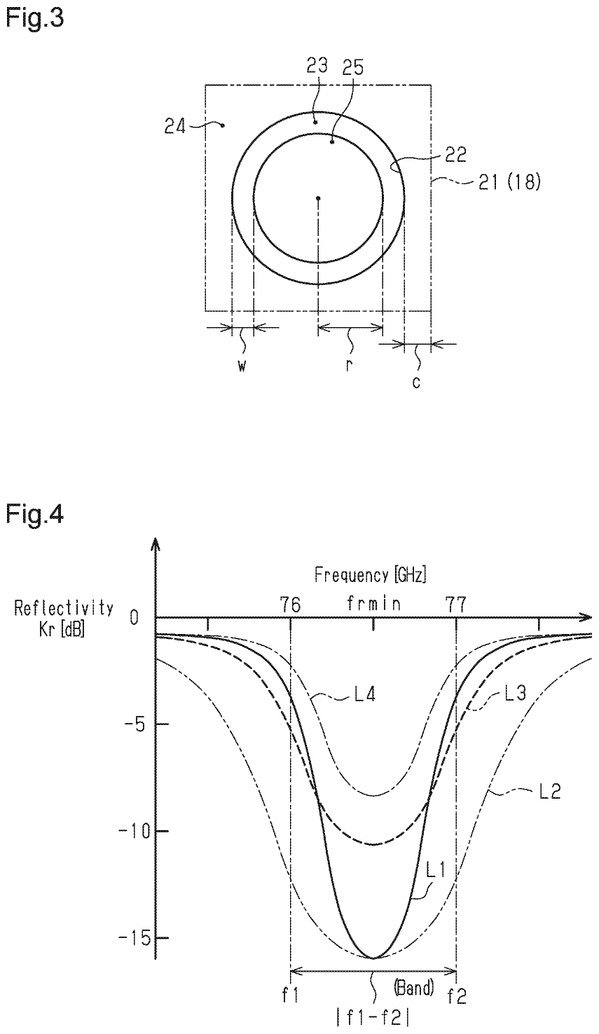

As shown in FIGS. 3 and 4, the radius of the patch region 25 in each unit thin film section 21 is represented by r. The minimum dimension of the conduction region 24 in the radial direction of the hole region 23 is represented by c. The width of the hole region 23 in the radial direction is represented by w. The radio wave reflectivity is represented by Kr. The frequency at which the reflectivity Kr is minimized is represented by frmin. The frequencies at the edges of the band including the frequency frmin are represented by f1 and f2. An index value related to the reflectivity Kr and the band of frequencies is represented by Q.

The length of one side of the unit thin film section 21, which has the shape of a square, is 2(r+w+c).

The following Expressions 1 to 3 hold among the radius r, a minimum dimension c, a width w, the frequency frmin, the frequencies f1, f2, the reflectivity Kr, and the index value Q.

$$\begin{matrix}frmin = - 91 r - 7.2 c + 11.8 w + 113.5 & ( Expression 1 ) \\ Q = \frac{Kr}{\vert f 1 - f 2 \vert} & ( Expression 2 ) \\ Q = 79 r - 2.4 c + 23 w - 38.6 & ( Expression 3 )\end{matrix}$$

Expressions 1 to 3 are defined in the following manner. A radio wave transmissive cover prior to formation of the conductive thin film 18 in FIG. 1 will first be discussed. This radio wave transmissive cover without a heating function will hereafter be referred to as an intermediate 26 to be distinguished from the radio wave transmissive cover 12, which includes the conductive thin film 18 and has a heating function. The intermediate 26 is designed such that reflection of radio waves transmitted from the radio wave radar device 11 is minimized within the possible range. The above Expressions 1 to 3 are determined through analysis such that, when the conductive thin film 18 is placed over the intermediate 26, Expressions 1 to 3 are guidance for designing optimal shapes of the hole region 23 and the patch region 25 that minimize the reflection of radio waves by the conductive thin film 18.

Expression 1 is guidance for designing the radius r, the minimum dimension c, and the width w at a specific frequency frmin, at which the radio wave reflectivity Kr is minimized as indicated by a characteristic line L1 in FIG. 4. However, Expression 1 only determines the frequency at which the reflectivity Kr is minimized. Expression 1 does not factor in the radio wave reflectivity Kr itself, which is the degree of reflection of radio waves in the frequency band that includes the frequency frmin as the median, as represented by characteristic lines L1 to L4 in FIG. 4.

In this regard, Expression 2 acquires the index value Q related to the reflectivity Kr and the frequency band. The two frequencies f1, f2 are used to determine the band that includes the frequency frmin. The frequency f1 is, for example, the value of the lower edge of the band (lower limit), and the frequency f2 is, for example, the value of the upper edge of the band (upper limit). The denominator of Expression 2 is the absolute value of the difference between the frequencies f1 and f2, which indicates the size of the band. The reflectivity Kr, which is the numerator of Expression 2, indicates the degree of reflection. That is, the reflectivity Kr indicates the quantity of incident radio waves that are reflected, or the amount of reflection, using dB. The closer to the 0 dB the reflectivity Kr is, the greater the amount of reflected radio waves becomes. The farther into the minus side from 0 dB the reflectivity Kr (toward the lower side in FIG. 4) is, the less likely the radio waves are to be reflected. For example, when the reflectivity Kr is −15 dB, radio waves are barely reflected, and mostly pass through.

It has been known that, when parameters defining the shape, the size, and the like of the hole region 23 and the patch region 25, such as the radius r, the minimum dimension c, and the width w, are changed, the relationship between the frequency and the reflectivity Kr is displaced from a target relationship. For example, the characteristic line L1, which is the solid line in FIG. 4, is shifted to the left or right in FIG. 4.

Expression 3 defines the relationship of the index value Q with the radius r, the minimum dimension c, and the width w.

In the first embodiment, the radius r, the minimum dimension c, and the width w are determined based on Expressions 1 to 3 such that the frequency frmin is in the range from 70 GHz to 80 GHz and that the index value Q is in the range from −15 to −5.

An operation of the first embodiment, which is configured as described above, will now be described. Advantages that accompany the operation will also be described.

When the conductive thin film 18 shown in FIG. 2 is energized, the conduction region 24 of each unit thin film section 21 generates heat. Some of the heat is transferred to the front surface of the radio wave transmissive cover 12 in the transmission direction via the protective layer 19, which is located forward of the conductive thin film 18 in the transmission direction. Thus, even if ice and snow accumulate on the radio wave transmissive cover 12, the heat melts the ice and snow. This limits attenuation of radio waves due to ice and snow, thereby reducing deterioration of the detection performance of the radio wave radar device 11 due to ice and snow.

Radio waves transmitted from the radio wave radar device 11 reach the conductive thin film 18 after passing through the base 13.

In the first embodiment, the radius r, the minimum dimension c, and the width w related to the shape of the conductive thin film 18 of the hole region 23 and the patch region 25 in each unit thin film section 21 are determined based on Expressions 1 to 3 as described above. When radio waves of a specific frequency band transmitted from the radio wave radar device 11 reach the patch region 25 of each unit thin film section 21, the patch region 25 is capable of outputting radio waves having a wavelength equivalent to that of the radio waves transmitted from the radio wave radar device 11. The output of the radio waves allows the radio wave transmissive cover 12 to function in a manner equivalent to a state in which the radio waves pass through the patch region 25. Accordingly, the required radio wave transmissivity is achieved. That is, the reflectivity Kr in the desired band of the frequency of the transmitted radio waves can be minimized (for example, to −15 dB), so that the reflection of radio waves in that band is effectively suppressed. The configuration thus prevents radio waves received by the radio wave radar device 11 from being reduced to an undetectable level.

In addition to the ones listed above, the first embodiment has the following advantages.

The conductive thin film 18 is used as a heater. Thus, as compared to a case in which a heating wire is used, the surface of the radio wave transmissive cover 12 is smooth. Also, since the conductive thin film 18 generates heat in a surface area, heat is generated evenly as compared to a case in which a heating wire is used.

Since the conductive thin film 18 is transparent, the conductive thin film 18 is difficult to see, which improves the appearance of the radio wave transmissive cover 12.

When the radio wave transmissive cover 12 is seen from the front in the transmission direction, the design layer 16 provided on the base 13 is seen through the protective layer 19, the conductive thin film 18, and the front base 17, which are transparent. The design layer 16 has a function of decorating the radio wave transmissive cover 12. The design layer 16 thus improves the appearance of the radio wave transmissive cover 12 and consequentially improves the appearance of the part of the vehicle including the radio wave transmissive cover 12.

The radio wave transmissive cover 12 has a function of concealing the radio wave radar device 11, which is arranged rearward of the radio wave transmissive cover 12 in the transmission direction. This prevents the radio wave radar device 11 from being seen from the front of the radio wave transmissive cover 12 in the transmission direction.

Since the hole region 23 is annular, the hole region 23 is less likely to be influenced by the angle of incidence of radio waves as compared to a case in which the hole region 23 has a rectangular shape like a frame with angular corners.

The patch region 25 is circular, and the hole region 23 is annular. Therefore, in designing the patch regions 25 and the hole regions 23, it is easy to arrange the patch regions 25 and the hole regions 23 regularly in relation to the conductive thin film 18.

The conductive thin film 18, which generates heat when energized, is arranged forward of the base 13 in the transmission direction. As compared to a case in which the conductive thin film 18 is arranged rearward of the base 13 in the transmission direction, the heat of the conductive thin film 18 is easily transferred to the protective layer 19. Ice and snow accumulated on the protective layer 19 are thus efficiently melted.

### Second Embodiment

A radio wave transmissive cover 12 according to a second embodiment will now be described.

In the second embodiment, the radius r, the minimum dimension c, and the width w are determined based on the following Expressions 4 to 6, in addition to Expressions 1 to 3, such that a watt density H is greater than or equal to 10 W/m². Expressions 4 to 6 hold among the radius r, the width w, the minimum dimension c, a resistance value Rs of the surface of the material of the unit thin film sections 21, the surface resistance value Rs' of the unit thin film sections 21, and the watt density H and a coefficient Yin the unit thin film sections 21.

$$\begin{matrix}{Rs}^{′} = Rs \div \frac{{\{ 2 ( r + w + c ) \}}^{2} - {π ( r + w )}^{2}}{{\{ 2 ( r + w + c ) \}}^{2}} & ( Expression 4 ) \\ H = Y ( - 628 r + 770 c - 625 w + 1096 ) & ( Expression 5 ) \\ Y = \frac{10}{{Rs}^{′}} & ( Expression 6 )\end{matrix}$$

The denominator of the fraction in Expression 4 represents the area of each unit thin film section 21, and the numerator represents the area of the section obtained by removing the hole region 23 and the patch region 25 from the unit thin film section 21. In other words, the numerator represents the area of the conduction region 24.

As described above, the radius r, the minimum dimension c, and the width w are determined based on a greater number of indexes than in the first embodiment.

The second embodiment thus has the same operations and advantages as the first embodiment. In addition, when the conductive thin film 18 is energized, the conduction region 24 of each unit thin film section 21 generates heat to melt snow. Thus, even if ice and snow accumulate on the radio wave transmissive cover 12, the generated heat reliably melts the ice and snow.

As a result, the second embodiment prevents the heat generating performance of the radio wave transmissive cover 12 from being reduced and also ensures the required radio wave transmissivity.

In a comparative example, if the gap between the sections of the thin conductor that are parallel with each other and extend in a reciprocating manner is increased in order to increase the radio wave transmissivity of the radio wave transmissive cover, the amount of the conductor is reduced. This may result in insufficient heat generating performance of the conductor for melting ice and snow accumulated on the radio wave transmissive cover. This configuration is thus unlikely to achieve the same advantages as those of the second embodiment.

The above-described embodiments may be modified as follows. The above-described embodiments and the following modifications can be combined as long as the combined modifications remain technically consistent with each other.

The conductive thin film 18 may be provided at a position different from the position forward of the base 13 in the transmission direction. For example, the conductive thin film 18 may be arranged in a middle section of or rearward of the base 13 in the transmission direction.

Other than a metal film such as an Ag film described above, a metal oxide film such as indium tin oxide (ITO) film or a plastic film including conductive fine particles may be used as the conductive thin film 18. Alternatively, the conductive thin film 18 may include different types of films overlapped with each other.

The radio waves transmitted and received by the radio wave radar device 11 may be radio waves different from millimeter waves.

The rear base 14 may be made of a plastic different from the above-described ASA plastic. For example, the rear base 14 may be made of a plastic such as acrylonitrile-ethylene-styrene copolymer (AES).

At least one of the front base 17 and the protective layer 19 may be made of a transparent plastic different from polycarbonate plastic, such as an acrylic plastic.

The protective layer 19 in the radio wave transmissive cover 12 may be omitted.

As long as the radio wave transmissive cover 12 is arranged forward of the radio wave radar device 11 in the transmission direction of radio waves, the radio wave transmissive cover 12 may be used for any type of the radio wave radar device 11.

Although the radio wave radar device 11 is typically used to monitor the situation in front of a vehicle, the radio wave radar device 11 may be used to monitor the situation behind the vehicle, the situation on the side of the front part of the vehicle, or the situation on the side of the rear part of the vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A radio wave transmissive cover used for a radio wave radar device configured to transmit and receive radio waves, the radio wave transmissive cover comprising:
a base made of a plastic, the base being configured to be arranged in a path of the radio waves and having transmissiveness for the radio waves; and
a conductive thin film, the conductive thin film being configured to be arranged in the path and generate heat when energized, wherein
the conductive thin film includes square unit thin film sections that are arranged regularly,
each unit thin film section includes
a hole region including an annular hole,
a conduction region located on an outer side of the hole region, and
a patch region that is surrounded by the hole region and insulated,
Expressions 1 to 3 hold among a radius r of the patch region, a minimum dimension c of the conduction region in a radial direction of the hole region, a width w of the hole region, a frequency frmin at which a reflectivity Kr of the radio waves is minimized, frequencies f1, f2 of edges of a band including the frequency frmin, and an index value Q related to the reflectivity Kr and a frequency band, and
$$\begin{matrix}frmin = - 91 r - 7.2 c + 11.8 w + 113.5 & ( Expression 1 ) \\ Q = \frac{Kr}{\vert f 1 - f 2 \vert} & ( Expression 2 ) \\ Q = 79 r - 2.4 c + 23 w - 38.6 & ( Expression 3 )\end{matrix}$$
the radius r, the minimum dimension c, and the width w are determined based on Expressions 1 to 3 such that the frequency frmin is in a range from 70 GHz to 80 GHz and that the index value Q is in a range from −15 to −5.

2. The radio wave transmissive cover according to claim 1, wherein
Expressions 4 to 6 hold among the radius r, the width w, the minimum dimension c, a resistance value Rs of a surface of a material of the unit thin film section, a surface resistance value Rs' of the unit thin film section, and a watt density H and a coefficient Yin the unit thin film section,
$$\begin{matrix}{Rs}^{′} = Rs \div \frac{{\{ 2 ( r + w + c ) \}}^{2} - {π ( r + w )}^{2}}{{\{ 2 ( r + w + c ) \}}^{2}} & ( Expression 4 ) \\ H = Y ( - 628 r + 770 c - 625 w + 1096 ) & ( Expression 5 ) \\ Y = \frac{10}{{Rs}^{′}} & ( Expression 6 )\end{matrix}$$
the radius r, the minimum dimension c, and the width w are determined based on Expressions 4 to 6, in addition to Expressions 1 to 3, such that the watt density H is greater than or equal to 10 W/m².

3. The radio wave transmissive cover according to claim 1, wherein
the base is arranged forward of the radio wave radar device in a transmission direction of the radio waves, and
the conductive thin film is made of a transparent material and arranged forward of the base in the transmission direction.
